(19) United States
(12) Patent Application Publication
(10) Pub. No.: US 2024/0049073 A1
(43) Pub. Date: Feb. 8, 2024

(54) METHOD AND APPARATUS FOR SUPPORTING SELF-CONFIGURATION AND SELF-OPTIMIZATION

(71) Applicant: SAMSUNG ELECTRONICS CO., LTD., Suwon-si (KR)

(72) Inventors: Lixiang XU, Beijing (CN); Weiwei WANG, Beijing (CN); Hong WANG, Beijing (CN)

(21) Appl. No.: 18/363,813

(22) Filed: Aug. 2, 2023

(30) Foreign Application Priority Data
Aug. 2, 2022 (CN) 202210924071.5
Feb. 13, 2023 (CN) 202310140607.9

(51) Int. Cl. H04W 36/00

(52) U.S. Cl. CPC H04W 36/0079; H04W 36/0061; H04W 36/249

(57) ABSTRACT

The disclosure relates to a 5G or 6G communication system for supporting a higher data transmission rate, including methods and apparatuses for supporting self-configuration and self-optimization. A method performed by a first network node in a communication system, includes receiving information related to a Master Cell Group (MCG) failure and detecting a failure cause based on the information related to the MCG failure.

### CROSS-REFERENCE TO RELATED APPLICATION

This application is based on and claims priority under 35 U.S.C. § 119 to Chinese Patent Application No. 202210924071.5 filed on Aug. 2, 2022, and Chinese Patent Application No. 202310140607.9 filed on Feb. 13, 2023, in the China National Intellectual Property Administration on and, respectively, the disclosure of which are incorporated by reference herein in their entirety.

### BACKGROUND

### 1. Field

The application relates to wireless communication technology, in particular to a method and apparatus for supporting self-configuration and self-optimization.

### 2. Description of Related Art

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### SUMMARY

The present disclosure relates to wireless communication systems and, more specifically, this disclosure relates to a method and apparatus for supporting self-configuration and self-optimization.

How to support self-configuration and self-optimization in dual connectivity or self-configuration and self-optimization of potential failure risk in a successful handover report is a problem to be solved at present.

According to an aspect of the present disclosure, there is provided a method performed by a first network node in a communication system, including: receiving information related to a Master Cell Group (MCG) failure; detecting a failure cause based on the information related to the MCG failure.

According to an embodiment of the present disclosure, the information related to the MCG failure includes at least one of the following information: an MCG failure indication; a cell identity of a primary cell (PCell) of the MCG failure; a time from the MCG failure to a secondary cell group (SCG) failure; a cell identity of a Primary SCG Cell (PSCell) of the SCG failure; a time from the MCG failure to a Radio Resource Control (RRC) reestablishment failure; a time from the MCG failure to a failure of execution of a mobility from a New Radio (NR) command; a time from the MCG failure to a failure of execution of a Radio Resource Control (RRC) reconfiguration including synchronization reconfiguration parameters; a time from the MCG failure to a failure occurring after successful execution of the mobility from the NR command; a time from the MCG failure to a failure occurring after successful execution of RRC reconfiguration including the synchronization reconfiguration parameters; a Secondary Cell Group (SCG) status; whether a timer T316 is configured; a status of the timer T316; indication information on the SCG failure after the MCG failure; a time of UE data interruption; indication information on an RRC reconfiguration failure after the MCG failure; indication information on a failure of the mobility from the NR command after the MCG failure; indication information on the RRC reestablishment failure after the MCG failure; location information on a UE; a cell identity of a target cell of RRC reconfiguration including the synchronization reconfiguration parameters; and a type of target Radio Access Technology (RAT) of the mobility from the NR command.

According to an embodiment of the present disclosure, the failure cause includes at least one of the following information: an unreasonable or wrong target cell configuration of Radio Resource Control (RRC) reconfiguration message including the synchronization reconfiguration parameters, an unreasonable target Radio Access Technology (RAT) configuration or a wrong RAT cell configuration of the mobility from the NR command, an unreasonable or wrong target cell configuration of the mobility from the NR command, an improper configuration of the timer T316, the Secondary Cell Group (SCG) failure, too late handover, and/or too late transmission of the RRC reconfiguration message including the synchronization reconfiguration parameters or the mobility from the NR command.

According to the embodiment of the present disclosure, receiving the information related to the Master Cell Group (MCG) failure includes receiving the information related to the Master Cell Group (MCG) failure from a User Equipment (UE), or receiving, through a base station associated with the MCG failure, the information related to the MCG failure transmitted by the UE.

According to another aspect of the present disclosure, there is provided a method performed by a first network node in a communication system, which includes: receiving a radio resource control (RRC) message including a successful handover report from a user equipment (UE); transmitting a first successful handover report message to a second network node based on the RRC message.

According to an embodiment of the present disclosure, the successful handover report follows an RRC format of a radio access technology supported by the second network node.

According to an embodiment of the present disclosure, the successful handover report includes a cause of the timer T316.

According to an embodiment of the present disclosure, the RRC message including the successful handover report information further includes a cell identity of a cell of the second network node.

According to an embodiment of the present disclosure, a second successful handover report message is transmitted to a third network node based on the first successful handover report message.

According to an embodiment of the present disclosure, the second successful handover report message transmitted to the third network node includes at least a part of content in the successful handover report.

According to another aspect of the present disclosure, there is provided a method performed by a first network node in a communication system, which includes: receiving a radio resource control (RRC) message including a successful PSCell change report from a user equipment (UE); transmitting a first conditional successful handover report message to a second network node based on the RRC message.

According to an embodiment of the present disclosure, the successful PSCell change report follows a RRC format of a radio access technology supported by the second network node.

According to an embodiment of the present disclosure, the RRC message including the successful PSCell change report further includes a cell identity of a cell of the second network node.

According to an embodiment of the present disclosure, the method further includes: receiving a second successful PSCell change report message from the second network node, and transmitting a third successful PSCell change report message to a third network node in response to the second successful PSCell change report message, wherein the second successful PSCell change report message or the third successful PSCell change report message includes at least one of the following: a UE access stratum identity, and at least a part of content in the successful PSCell change report message.

According to an embodiment of the present disclosure, the successful PSCell change report follows the RRC format of the radio access technology supported by the first network node.

According to an embodiment of the present disclosure, the first successful PSCell change report message includes at least one of the following: a container of the successful PSCell change report, the UE access stratum identity, and at least a part of the content in the successful PSCell change report message.

According to an embodiment of the present disclosure, in response to receiving the first successful PSCell change report message, a second successful PSCell change report message is transmitted to the third network node, and the second successful PSCell change report message includes at least one of the following: a container of the successful PSCell change report, the UE access stratum identity, and at least a part of the content in the successful PSCell change report.

According to an embodiment of the present disclosure, the successful PSCell change report includes at least one of the following information: the cause of the timer T316, a time from receiving a Conditional PSCell Change (CPC) configuration to a CPC execution, a time from receiving a Conditional PSCell Addition (CPA) configuration to a CPA execution, information on a source primary SCG cell (PSCell), information on a target PSCell, and location information of a UE; a cause of a successful PSCell change report; common random access information; a Cell-Radio Network Temporary Identifier (C-RNTI) allocated by a source PSCell; a C-RNTI allocated by a target PSCell.

According to another aspect of the present disclosure, there is provided a method performed by a user equipment (UE) in a communication system, which includes: transmitting information related to a Mater Cell Group (MCG) failure to a first network node; wherein a failure cause is detected based on the information related to the MCG failure.

According to an embodiment of the present disclosure, the information related to the MCG failure includes at least one of the following information: an MCG failure indication; a cell identity of a primary cell (PCell) of the MCG failure; a time from the MCG failure to a Secondary Cell Group (SCG) failure; a cell identity of a Primary SCG Cell (PSCell) of the SCG failure; a time from the MCG failure to a Radio Resource Control (RRC) reestablishment failure; a time from the MCG failure to a failure of execution of a mobility from a New Radio (NR) command; a time from the MCG failure to a failure of an execution of a Radio Resource Control (RRC) reconfiguration including synchronization reconfiguration parameters; a time from the MCG failure to a failure occurring after successful execution of the mobility from the NR command; a time from the MCG failure to a failure occurring after a successful execution of RRC reconfiguration including the synchronization reconfiguration parameters; a Secondary Cell Group (SCG) status; whether a timer T316 is configured; a status of the timer T316; indication information on the SCG failure after the MCG failure; a time of UE data interruption; indication information on an RRC reconfiguration failure after the MCG failure; indication information on a failure of mobility from the NR command after the MCG failure; indication information on an RRC reestablishment failure after the MCG failure; location information of a UE; a cell identity of a target cell of the RRC reconfiguration including the synchronization reconfiguration parameters; and a type of a target Radio Access Technology (RAT) of the mobility from the NR command.

According to an embodiment of the present disclosure, the failure cause includes at least one of the following information: an unreasonable or wrong target cell configuration of a Radio Resource Control (RRC) reconfiguration message including the synchronization reconfiguration parameters, an unreasonable target Radio Access Technology (RAT) configuration or a wrong Radio Access Technology (RAT) cell configuration of the mobility from the NR command, an unreasonable or wrong target cell configuration of the mobility from the NR command, an improper configuration of the timer T316, the Secondary Cell Group (SCG) failure, too late handover, and/or too late transmission of the RRC reconfiguration message including the synchronization reconfiguration parameters or the mobility from the NR command.

According to an embodiment of the present disclosure, receiving the information related to the master cell group (MCG) failure includes: receiving the information related to the master cell group (MCG) failure from the user equipment (UE), or receiving, through a base station associated with the master cell group (MCG) failure, the information related to the master cell group (MCG) failure transmitted by the UE.

According to another aspect of the present disclosure, there is provided a method performed by a user equipment (UE) in a communication system, which includes: transmitting a radio resource control (RRC) message including a successful handover report to a first network node; wherein a first successful handover report message is transmitted to a second network node based on the RRC message.

According to an embodiment of the present disclosure, the successful handover report follows an RRC format of a radio access technology supported by the second network node.

According to an embodiment of the present disclosure, the successful handover report includes a cause of a timer T316.

According to an embodiment of the present disclosure, the RRC message including the successful handover report information further includes a cell identity of a cell of the second network node.

According to an embodiment of the present disclosure, a second successful handover report message is transmitted to a third network node based on the first successful handover report message.

According to an embodiment of the present disclosure, the second successful handover report message transmitted to the third network node includes at least a part of content in the successful handover report.

According to another aspect of the present disclosure, there is provided a method performed by a user equipment (UE) in a communication system, which includes: transmitting a radio resource control (RRC) message including a successful PSCell change report to a first network node; wherein a first conditional successful handover report message is transmitted to a second network node based on the RRC message.

According to an embodiment of the present disclosure, the successful PSCell change report follows an RRC format of a radio access technology supported by the second network node.

According to an embodiment of the present disclosure, the RRC message including the successful PSCell change report further includes a cell identity of a cell of the second network node.

According to an embodiment of the present disclosure, a second successful PSCell change report message is received from the second network node, and a third successful PSCell change report message is transmitted to a third network node in response to the second successful PSCell change report message, and the second successful PSCell change report message or the third successful PSCell change report message includes at least one of the following: a UE access stratum identity, and at least a part of content in the successful PSCell change report information.

According to an embodiment of the present disclosure, the successful PSCell change report follows a RRC format of a radio access technology supported by the first network node.

According to an embodiment of the present disclosure, the first successful PSCell change report message includes at least one of the following: a container of the successful PSCell change report, a UE access stratum identity, and at least a part of the contents in the successful PSCell change report information.

According to an embodiment of the present disclosure, in response to receiving the first successful PSCell change report message, the second successful PSCell change report message is transmitted to the third network node, and the second successful PSCell change report message includes at least one of the following: a container of the successful PSCell change report, a UE access stratum identity, and at least a part of content in the successful PSCell change report.

According to an embodiment of the present disclosure, the successful PSCell change report includes at least one of the following information: a cause of a timer T316, a time from receiving a Conditional PSCell Change (CPC) configuration to a CPC execution, a time from receiving a Conditional PSCell Addition (CPA) configuration to a CPA execution, information on a source primary SCG cell (PSCell), information on a target PSCell, and location information of the UE; a cause of a successful PSCell change report; common random access information; a Cell-Radio Network Temporary Identifier (C-RNTI) allocated by a source PSCell; a C-RNTI allocated by a target PSCell.

According to another aspect of the present disclosure, there is provided a first network node in a communication system, including a transceiver configured to transmit and receive signals; and a controller coupled with the transceiver and configured to perform operations in the method according to the present disclosure.

According to another aspect of the present disclosure, there is provided a user equipment (UE) in a communication system, including a transceiver configured to transmit and receive signals; and a controller coupled with the transceiver and configured to perform operations in the method according to the present disclosure.

With the method for supporting self-configuration and self-optimization, various information on a failure or a handover can be obtained, so as to carry out reasonable configuration and optimization and reduce occurrence of a problem or a failure.

Advantages, and salient features of the invention will become apparent to those skilled in the art from the following detailed description, which, taken in conjunction with the annexed drawings, discloses exemplary embodiments of the invention.

According to various embodiments of the present disclosure, method and apparatus for supporting self-configuration and self-optimization.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system architecture diagram of System Architecture Evolution (SAE);

FIG. 2 illustrates a schematic diagram of an initial overall architecture of 5G;

FIG. 3 illustrates a flowchart of a first method according to an embodiment of the present disclosure;

FIG. 4 illustrates a flowchart of a second method according to an embodiment of the present disclosure;

FIG. 5 illustrates a flowchart of a third method according to an embodiment of the present disclosure;

FIG. 6 illustrates a flowchart of a fourth method according to an embodiment of the present disclosure;

FIG. 7 illustrates a flowchart of a fifth method according to an embodiment of the present disclosure;

FIG. 8 illustrates a flowchart of a sixth method according to an embodiment of the present disclosure;

FIG. 9 illustrates a flowchart of a seventh method according to an embodiment of the present disclosure;

FIG. 10 illustrates a flowchart of an eighth method according to an embodiment of the present disclosure;

FIG. 11 illustrates a flowchart of a ninth method according to an embodiment of the present disclosure;

FIG. 12 illustrates a block diagram of a network node according to an embodiment of the present disclosure; and

FIG. 13 illustrates a block diagram of a User Equipment (UE) according to an embodiment of the present disclosure.

### DETAILED DESCRIPTION

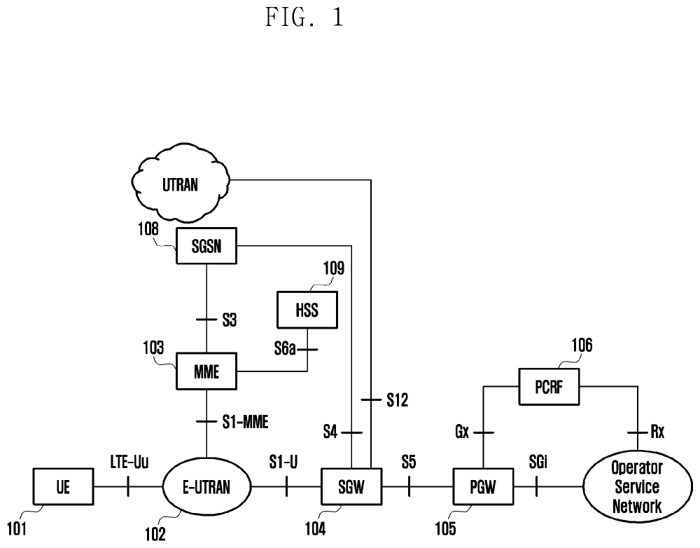

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the mode for invention below, it can be advantageous to set forth definitions of certain terms and phrases used throughout the present patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in an appropriate computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present disclosure. For example, unless otherwise defined, the technical terms or scientific terms used in the disclosure shall have the ordinary meaning understood by those with ordinary skills in the art to which the present disclosure belongs.

It should be understood that “first”, “second” and similar terms used in the disclosure do not express any order, quantity or importance, but are only used to distinguish different components. Similar terms such as singular forms “a”, “an” or “the” do not express a limitation of quantity, but express the existence of at least one of the referenced item, unless the context clearly dictates otherwise.

As used herein, any reference to “an example” or “example”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

It will be further understood that similar terms such as “include” or “comprise” mean that elements or objects appearing before the term encompass the listed elements or objects appearing after the term and their equivalents, but other elements or objects are not excluded. Similar terms such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

The following description with reference to the accompanying drawings is provided to assist in a comprehensive understanding of various embodiments of the present disclosure as defined by the claims and their equivalents. The following description includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and phrases used in the following description and claims are not limited to the bibliographical meanings, but, are merely used by the inventor(s) to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed functions, operations or components which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude a possibility of the existence of one or more other characteristics, numbers, steps, operations, constituent elements, components or combinations thereof.

The term “or” used in various embodiments of the present disclosure includes any or all of combinations of listed items. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

FIGS. 1 to 11 discussed below and various embodiments for describing the principles of the present disclosure in the present patent document are only for illustration and should not be interpreted as limiting the scope of the disclosure in any way. Those skilled in the art will understand that the principles of the present disclosure can be implemented in any suitably arranged system or device.

FIG. 1 illustrates an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information on the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS)109 is a home subsystem of the UE, and is responsible for protecting user information including a current location of the user equipment, an address of a serving node, user security information, and packet data context of the user equipment, etc.

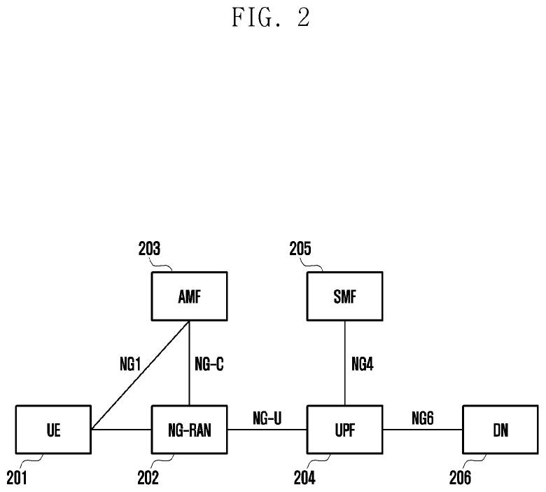

FIG. 2 illustrates an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also referred to as ng-gNB) that provides UE with interfaces to access the radio network. An access control and mobility management function entity (AMF) 203 is responsible for managing mobility context and security information on the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

How to support mobility robustness in dual connectivity is a problem that needs to be solved at present. In addition, for a successful handover, there may be a failure or a potential failure in the handover procedure, and thus how to avoid a potential failure is also a problem that needs to be solved.

In order to improve a reliability of a primary SCG cell (PSCell, SpCell (a primary cell of a master or secondary cell group) of a secondary cell group) change, a Conditional PSCell Change (CPC) is defined. The CPC is internal to a Secondary Node (SN). Furthermore, a Conditional PSCell Addition (CPA) and an inter-SN CPC procedure are further defined. An unreasonable configuration or trigger of the CPA or CPC procedure will also lead to a Secondary Cell Group (SCG) failure. How to identify a type of the failure for a reasonable optimization is a problem that needs to be solved at present.

In the dual connectivity state, the following failures might occur in the UE: a Master Cell Group (MCG) failure, a SCG failure after the MCG failure, a RRC reconfiguration failure or a failure of execution of a mobility from a New Radio (NR) command (MobilityFromNRCommand) after the MCG failure, an RRC reestablishment failure after the MCG failure. The RRC reconfiguration may be an RRC reconfiguration message including synchronization reconfiguration parameters. In these failure scenarios, how to identify types of the failures on a base station side for reasonable optimization is a problem that needs to be solved at present.

For a successful handover, there may be a failure or a risk of a potential failure in the handover procedure, which may be caused by a configuration of a source base station or a target base station. What information is transmitted and how information on a successful handover is transmitted to a correct node are currently unsolved problems. At the same time, two or three of the source base station, the target base station and a base station receiving a successful handover report can also be base stations which supports different radio access technologies. How to make each base station understand the successful handover report is also a problem to be solved.

By a method of the present disclosure which supports self-configuration and self-optimization, a failure cause can be correctly identified in case of a primary cell group failure in the dual connectivity state, so as to carry out reasonable optimization, reduce occurrence of a failure, ensure service continuity, and reduce labor cost of operators.

In addition, the method of the present disclosure which supports self-configuration and self-optimization can also support a potential problem in the successful handover procedure or in the successful PSCell change procedure, and transmit the successful handover report to the correct node for optimization, thus avoiding the potential problem in the future.

In an embodiment according to the present disclosure, a UE Radio Link Failure Report (UE RLF Report) includes an indication of a MCG failure, a cell identity of a primary cell (PCell) of the MCG failure, a time from the MCG failure to the SCG failure, a cell identity of a PSCell of the SCG failure, a time of the MCG failure to a Radio Resource Control (RRC) reestablishment failure, a time from the MCG failure to a failure of execution of the mobility from the NR command, a time from the MCG failure to a failure of execution of a RRC reconfiguration including synchronization reconfiguration parameters, a time from the MCG failure to a failure occurring after successfully executing the mobility from the NR command, a time from the MCG failure to a failure occurring after successfully executing the RRC reconfiguration including the synchronization reconfiguration parameters, a SCG status, whether a timer T316 is configured, a status of the timer T316, indication information on the SCG failure after the MCG failure, indication information on an RRC reconfiguration failure after the MCG failure, indication information on a failure of the mobility from the NR command after the MCG failure, indication information on an RRC reestablishment failure after MCG failure, location information on a UE, a cell identity of a target cell of the RRC reconfiguration including the synchronization reconfiguration parameters, and/or a target RAT type of the mobility from the NR command. The above information can also be included in MCG failure information (MCGFailureInformation) or other RRC messages. The SCG status includes: SCG suspend, SCG activation, SCG deactivation, whether a PSCell change is ongoing, whether a conditional reconfiguration evaluation of a Conditional Handover (CHO) is ongoing, whether a CPC configuration evaluation is ongoing, and/or whether a CPA configuration evaluation is ongoing. The timer T316 starts when the UE transmits the MCG failure information to the base station, and ends when the UE receives an RRC release message or the RRC reconfiguration message containing the synchronization reconfiguration parameters or a mobility from the NR command or the UE initiates an RRC reestablishment procedure.

In an embodiment according to the present disclosure, the Successful Handover (HO) Report (SHR) includes a cause of the timer T316. The SHR also includes a time from receiving a CPC configuration to a CPC execution or a time from receiving a CPA configuration to a CPA execution.

In an embodiment according to the present disclosure, if the SHR is resulted from a configuration of a source base station, the SHR is encoded according to an RRC of a radio access technology supported by the source base station, and in a RRC message including the SHR, a cell identity of a source cell is further included out of the SHR. If the SHR is resulted from a configuration of a target base station, the SHR is encoded according to the RRC of the radio access technology supported by the target base station, and a cell identity of a target cell is further included out of the SHR.

In an embodiment according to the present disclosure, if the SHR or PSCell change report is resulted from a configuration of a base station which a source PSCell belongs to, the SHR or PSCell change report is encoded according to the RRC of the radio access technology supported by a base station which the source PSCell belongs to, and in the RRC message containing the SHR or PSCell change report, a cell identity of the source PSCell is further included out of the SHR or PSCell change report. If the SHR or PSCell change report is led to by a configuration of a base station where a target PSCell is located, the SHR or PSCell change report is encoded according to the RRC of the radio access technology supported by a target base station, and a cell identity of the target cell is further included external to the SHR or PSCell change report in the RRC message containing the SHR or PSCell change report.

As understood by those skilled in the art, the “timer T316” described in this disclosure can also be referred to as a timer, and these terms are used interchangeably in this disclosure.

Exemplary embodiments of the present disclosure are further described below with reference to the accompanying drawings.

The text and drawings are provided as examples only to help understand the present disclosure. They should not be construed as limiting the scope of the present disclosure in any way. Although certain embodiments and examples have been provided, based on the disclosure herein, it is apparent to those skilled in the art that changes can be made to the illustrated embodiments and examples without departing from the scope of this disclosure.

It should be noted that the methods of the present disclosure are applicable to PSCell change procedures, including a normal PSCell change procedure and a CPC or CPA procedure. For the CPC and CPA procedures, the CPC procedure is taken as an example for description in the present disclosure, and the problems and methods described in present disclosure are also applicable to the CPA procedure. When it is applied to the CPA procedure, it is only needed to replace the CPC with the CPA. Similarly, the methods described in the present disclosure are also applicable to the Conditional PSCell Addition or Change (CPAC) procedure, and the CPC is replaced by the CPAC when applicable.

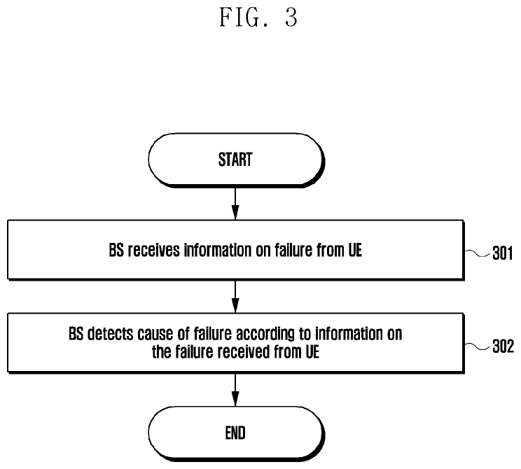

An example of a first method of supporting self-configuration and self-optimization in the present disclosure is illustrated in FIG. 3. The method comprises the following steps:

Step 301: a base station receives information on a failure from a UE. The base station may be a master node serving the UE when a MCG failure occurs, a secondary node serving the UE when the failure occurs, or a base station serving the UE after successfully performing RRC reconfiguration or the mobility from an NR command after the MCG failure occurs, or a base station successfully performing an RRC reestablishment after the MCG failure occurs. The information on the failure includes one or more of the following information or information elements:
an MCG failure indication;
a cell identity of a primary cell (PCell) of the MCG failure;
a time from the MCG failure to a SCG failure;
a cell identity of a PSCell of the SCG failure;
a time from the MCG failure to an RRC reestablishment failure;
a time from the MCG failure to a failure of execution of a mobility from an NR command;
a time from the MCG failure to a failure of execution of an RRC reconfiguration including synchronization reconfiguration parameters;
a time from the MCG failure to a failure occurring after successful execution of the mobility from the NR command;
location information on the UE;
a SCG status, which includes: SCG suspend, SCG activation, SCG deactivation, whether a PSCell change is ongoing, whether a conditional reconfiguration evaluation of conditional handover (CHO) is ongoing, whether a CPC configuration evaluation is ongoing, and/or whether a CPA configuration evaluation is ongoing;
whether a timer T316 is configured. The Timer T316 starts when the UE transmits the information on the MCG failure to the base station, and ends when the UE receives an RRC release message or receives an RRC reconfiguration message including synchronization reconfiguration parameters or receives the mobility from the NR command or the UE initiates the RRC reestablishment procedure.
a status of the timer T316;
indication information on the SCG failure after the MCG failure;
a time of UE data interruption, which can be a time from the UE receiving the last downlink data packet in a PCell to a successful MCG recovery, or a time from the UE transmitting the last uplink data packet in the PCell to a successful MCG recovery, or a time from the UE receiving of the last downlink data packet in the PCell to the UE receiving the first downlink data packet in the MCG after the successful MCG recovery, or a time from the UE transmitting the last uplink data packet in the PCell to the UE transmitting the first uplink data packet in the MCG after the successful MCG recovery.
indication information on an RRC reconfiguration failure after the MCG failure;
indication information on a failure of the mobility from the NR command after the MCG failure
indication information on an RRC reestablishment failure after the MCG failure;
a cell identity of a target cell of the mobility from the NR command.

The base station can receive one or more of the above information through MCG failure information (MCGFailureInformation) or a RLF report. The base station can receive one or more of the above information through a UE information response message or other messages.

The base station can receive the above information directly from the UE, the base station can also receive the above information from the UE through a secondary node serving the UE, the base station can also receive the above information from the UE through the base station to which the UE successfully re-access after the failure, the base station can also receive the above information from the UE through a base station serving the UE after successfully executing the RRC reconfiguration or successfully executing the mobility from the NR command after the MCG failure, and the base station can also receive the above information from the UE through other base stations. The base station serving the UE after successfully executing the RRC reconfiguration or successfully executing the mobility from the NR command after the MCG failure can directly receive the above information from the UE, and the base station serving the UE after successfully executing the RRC reconfiguration or successfully executing the mobility from the NR command after the MCG failure can also obtain the above information from the UE through other base stations, such as a third base station, which the UE successfully re-accesses to after a failure occurs after successful RRC reconfiguration or successful execution of the mobility from the NR command, the third base station obtains the above information from the UE, and the third base station transmits the same to the base station serving the UE after successfully executing the RRC reconfiguration or successfully executing the mobility from the NR command after the MCG failure occurs.

Step 302: The base station detects a failure cause according to the information on the failure received from the UE. The base station can also make corresponding optimization according to the failure cause. The failure cause includes: an unreasonable or wrong target cell configuration of the RRC reconfiguration message including synchronization reconfiguration parameters, an unreasonable target RAT configuration or a wrong RAT cell configuration of the mobility from the NR command, an unreasonable or wrong target cell configuration of the mobility from the NR command, improper configuration of the timer T316, SCG failure, too late handover, and/or too late transmission of the RRC reconfiguration message including synchronization reconfiguration parameters or the mobility from the NR command.

So far, the first method for supporting self-configuration and self-optimization in the present disclosure is described. By this method, in case that the master cell group fails in the dual connectivity state, the failure cause can be correctly identified for reasonable optimization, thus reducing occurrence of a failure, ensuring service continuity and reducing labor cost of operators.

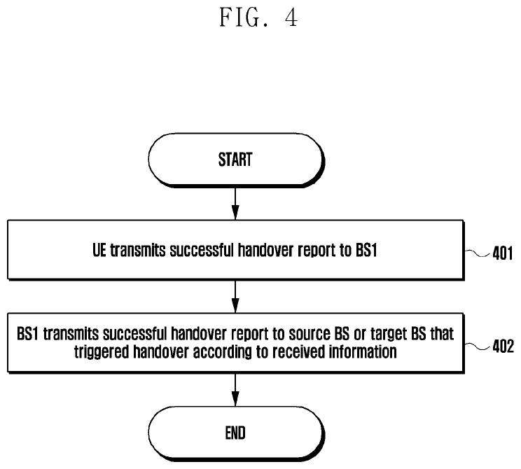

An example of the second method for supporting self-configuration and self-optimization in the present disclosure is illustrated in FIG. 4. The method comprises the following steps:

Step 401: a UE transmits a successful handover report to the base station 1. The UE may transmit the successful handover report to the base station 1 after the base station 1 requests the successful handover report of the UE.

For example, the UE may transmit the successful handover report to the base station 1 through a UE information response message or other RRC message.

If the successful handover report is caused by successful handover configuration configured by a source PCell, the successful handover report follows or uses the radio access technology RRC format supported by the source PCell, and a cell identity of the source PCell is included out of the successful handover report in the RRC message (such as the UE information response message). For example, the successful handover report is stored due to configuration parameters related to the timer T310 or timer T312.

If the information on successful handover is caused by the handover configuration configured by the target PCell of the handover, the successful handover report follows or complies with the radio access technology RRC format supported by the target PCell, and a cell identity of the target PCell is included out of the successful handover report in the RRC message (such as the UE information response message). For example, the successful handover report is stored due to the configuration parameters related to the timer T304.

The cause of the successful handover report in the message transmitted by the UE may also include the cause of the timer T316.

Step 402: The base station 1 transmits a successful handover report to the source base station that triggered the handover or the target base station according to the received information.

The base station 1 receives the RRC message containing the successful handover report from the UE.

The base station 1 transmits a successful handover report to the base station which the source PCell belongs to or transmits the successful handover report to the base station which the target PCell belongs to according to the received information. Herein, for example, the received information may be information included in the received RRC message.

For example, the base station 1 transmits the successful handover report to the corresponding base station according to the cell identity contained in the received RRC message. The cell identity is included out of the successful handover report in the RRC message.

The base station receives the successful handover report from the base station 1. For example, the base station may be the corresponding base station that receives the successful handover report transmitted by the base station 1. Herein, the base station receiving the message from the base station 1 is referred to as the base station 2. Since the successful handover report is encoded according to or with reference to the RRC format supported by the base station 2, the base station 2 can parse the content of the successful handover report without requiring the base station 2 to parse the RRC of other radio access technologies.

The base station 2 detects a problem according to the information on the received successful handover report, and can also optimize subsequent handover configuration parameters.

So far, the second method for supporting self-configuration and self-optimization in the present disclosure is described. By this method, the successful handover report, especially the successful handover report of inter-different RAT, can be supported, and the causes of potential failures can be correctly identified, so as to make reasonable optimization, avoid a failure, ensure service continuity, and reduce labor cost of operators. For example, respective base station can analyze and judge whether there is a potential failure and/or the cause of the potential failure based on the information in the received successful handover report.

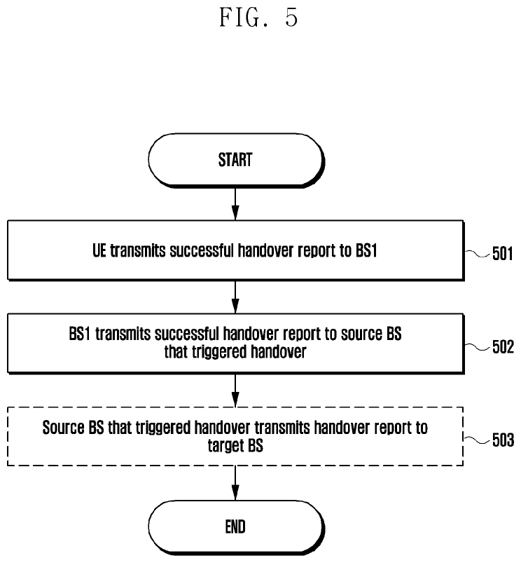

An example of the third method for supporting self-configuration and self-optimization in the present disclosure is illustrated in FIG. 5. The method comprises the following steps:

Step 501: a UE transmits a successful handover report to the base station 1. The UE may transmit the successful handover report to the base station 1 after the base station 1 requests the successful handover report of the UE.

The UE may transmit the successful handover report to the base station 1 through a UE information response message or other RRC message.

The successful handover report uses or follows or refers to the radio access technology RRC format supported by the source PCell, and a cell identity of the source PCell is included out of the successful handover report in the RRC message (such as the UE information response message).

The cause of the successful handover report in the message transmitted by the UE may also include the cause of the timer T316.

Step 502: the base station 1 receives an RRC message containing the successful handover report from the UE.

The base station 1 transmits the successful handover report to the base station which the source PCell belongs to. Since the successful handover report uses the RRC format of the radio access technology supported by the source PCell, the source base station can parse the contents of the successful handover report without resulting in any additional complexity to the source base station. If the base station which the source PCell belongs to determines that the successful handover report is caused by the configuration of the base station which the target PCell belongs to, the step 503 is performed.

Step 503: The base station which the source PCell triggering the handover belongs to transmits a message to the base station which the target PCell belongs to. The message may contain the successful handover report. The source base station that triggered the handover can also include the contents of the successful handover report in an inter-base station interface message to be transmitted to the target base station. In this way, the target base station can correctly obtain the contents of the successful handover report even if it does not support the RRC of the source base station. The source base station that triggered the handover can also transmit, to the target base station, information on resulting in the successful handover report and/or information related to the target base station such as configuration information related to T304, instead of all the information in the successful handover report, so as to reduce the information transmitted in the inter-base station interfaces. In the present disclosure, the information on resulting in the successful handover report can be, for example, a threshold or a conditional parameter. When the threshold or conditional parameter is satisfied, the successful handover report can be stored and/or generated; however, the information on resulting in the successful handover report is not limited to this.

The target base station can optimize the subsequent handover.

So far, the third method for supporting self-configuration and self-optimization in the present disclosure is described. By this method, the successful handover report, especially the successful handover report of inter-different RAT, can be supported, and the causes of potential failures can be correctly identified, so as to carry out reasonable optimization, reduce occurrence of a failure, ensure service continuity, and reduce labor cost of operators.

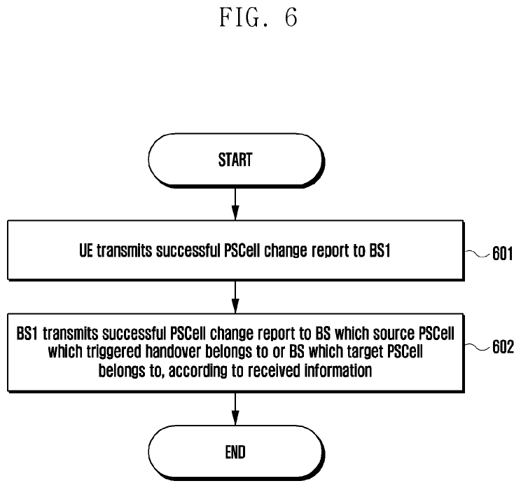

An example of the fourth method for supporting self-configuration and self-optimization in the present disclosure is illustrated in FIG. 6. The method comprises the following steps:

Step 601: a UE transmits a successful PSCell change report to the base station 1. The UE may transmit the successful PSCell change report to the base station 1 after the base station 1 requests the successful PSCell change report to the UE.

The successful PSCell change report may use a successful handover report or a newly defined successful PSCell change report. If the successful handover report is used, the UE can transmit the information on the successful PSCell change report to the base station 1 through the successful handover report after the base station 1 requests the successful handover report to the UE.

The UE may transmit the information on the successful PSCell change report to the base station 1 through a UE information response message or other RRC message.

If the information on the successful PSCell change is caused by the successful PSCell change configuration configured by the source PSCell, the successful handover report or the successful PSCell change report follows or refers to the RRC format of the radio access technology supported by the source PSCell, and a cell identity of the source PSCell is included out of the successful handover report or the successful PSCell change report in an RRC message (such as the UE information response message). For example, the successful handover report or the successful PSCell change report is stored due to configuration parameters related to the timer T310 or timer T312.

If the information on the successful PSCell change is caused by the successful PSCell change configuration configured by the target PSCell, the successful handover report or the successful PSCell change report uses the RRC format of the radio access technology supported by the target PSCell, and a cell identity of the target PSCell is included out of the successful handover report or the successful PSCell change report in an RRC message (such as the UE information response message). For example, the successful handover report or the successful PSCell change report is stored due to configuration parameters related to the timer T304.

The cause of the successful PSCell change report in the message transmitted by the UE may also include the cause of the timer T316.

For the CPC or the CPA, the successful handover report transmitted by the UE may also include a time from the CPC or CPA configuration to the CPC or CPA execution.

The successful PSCell change report may also include one or more of the following information:

information on the source PSCell, including the cell identity of the source PSCell and measurement of the source PSCell. The cell identity includes a Public Land Mobile Network (PLMN) identity, a cell identity under the PLMN, and further includes a Tracking Area Code (TAC);
information on the target PSCell, including the cell identity of the target PSCell and measurement of the target PSCell. The cell identity includes a PLMN identity, a cell identity under the PLMN, and a tracking area code (TAC);
location information of the UE;
cause of the successful PSCell change report;
common random access information;
a Cell-Radio Network Temporary Identifier (C-RNTI, RRC cell radio network temporary identifier) allocated by the source PSCell;
a C-RNTI allocated by the target PSCell.

Step 602: the base station 1 transmits the successful PSCell change report to the base station which the source PSCell triggering the handover belongs to or the base station which the target PSCell belongs to according to the received information.

The base station 1 receives an RRC message containing the successful handover report or the successful PSCell change report from the UE.

The base station 1, according to the received information, transmits the successful handover report or the successful PSCell change report to the base station which the source PCell belongs to, or transmits the successful handover report or the successful PSCell change report to the base station which the target PCell belongs to.

The base station 1 transmits the successful handover report or the successful PSCell change report to the corresponding base station according to the cell identity contained in the received RRC message. The cell identity is included out of the successful handover report or the successful PSCell change report in the RRC message.

The base station receives the successful handover report or the successful PSCell change report from the base station 1. Herein, the base station receiving the message from the base station 1 is referred to as the base station 2. Since the successful handover report or the successful PSCell change report is encoded according to the RRC format supported by the base station 2, the base station 2 can parse the contents of the successful handover report or the successful PSCell change report without requiring the base station 2 to parse the RRC of other radio access technologies.

The base station 2 optimizes the subsequent PSCell changes to avoid any potential failure.

So far, the fourth method for supporting self-configuration and self-optimization in the present disclosure is described. By this method, the successful PSCell change report, especially the successful PSCell change report in the PSCell change procedure of inter-different RAT, can be supported, and the cause of potential failure can be correctly identified, so as to carry out reasonable optimization, reduce occurrence of a failure, ensure service continuity, and reduce labor cost of operators.

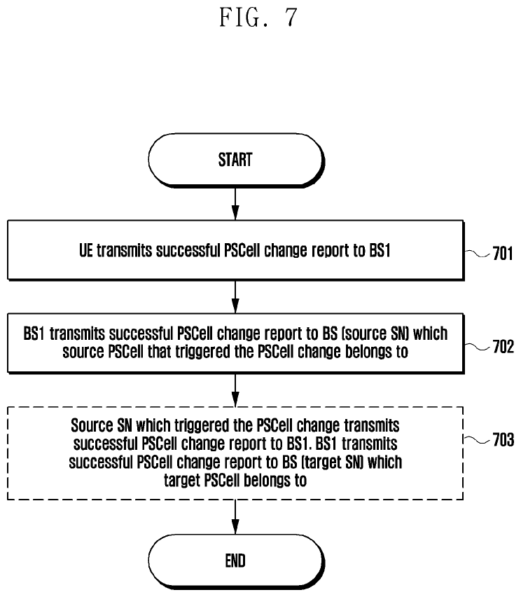

An example of the fifth method for supporting self-configuration and self-optimization in the present disclosure is illustrated in FIG. 7. The method comprises the following steps:

Step 701: a UE transmits a successful PSCell change report to the base station 1. The UE may transmit the successful PSCell change report to the base station 1 after the base station 1 requests the successful PSCell change report to the UE.

The successful PSCell change report may use a successful handover report or a newly defined successful PSCell change report. If the successful handover report is used, the UE can transmit information on the successful PSCell change report to the base station 1 through the successful handover report after the base station 1 requests the successful handover report report of the UE.

The UE may transmit the successful PSCell change report to the base station 1 through a UE information response message or other RRC messages.

The successful handover report or the successful PSCell change report follows or complies with the RRC format of the radio access technology supported by the source PSCell, and a cell identity of the source PSCell is included out of the successful handover report or the successful PSCell change report in the RRC message (such as the UE information response message).

The cause of the successful PSCell change report in the message transmitted by the UE may also include the cause of the timer T316.

For the CPC or the CPA, the successful handover report transmitted by the UE may also include a time from the CPC or CPA configuration to the CPC or CPA execution.

The successful PSCell change report also includes the contents described at step 601, which will not be repeated here.

Step 702: the base station 1 transmits a successful PSCell change report to the base station which the source PSCell that triggered the PSCell change belongs to.

The base station 1 receives the RRC message containing the successful handover report or the successful PSCell change report originating from the UE. The base station 1 transmits a successful handover report or a successful PSCell change report to the base station which the source PSCell belongs to. Since the successful handover report or the successful PSCell change report follows or uses the RRC format of the radio access technology supported by the source PSCell, the base station which the source PSCell belongs to can parse the contents of the successful handover report or the successful PSCell change report without resulting in additional complexity to the base station which the source PSCell belongs to. If the base station which the source PSCell belongs to determines that the successful handover report is caused by the configuration of the base station which the target PSCell belongs to, the step 703 is executed.

Step 703: the source SN which triggered the PSCell change transmits the successful PSCell change report to the base station 1. The base station 1 transmits the successful PSCell change report to the base station which the target PSCell belongs to.

The base station which the source PSCell belongs to transmits a message to the base station 1. The message contains a UE access stratum identity of the UE at an inter-base station interface. The message may also include the successful handover report or the successful PSCell change report.

The base station 1 transmits a message to the base station which the target PSCell belongs to. The message may include the successful handover report or the successful PSCell change report, or the base station 1 includes the information in the successful handover report or the successful PSCell change report in the inter-base station interface message which is transmitted to the base station which the target PSCell belongs to, instead of including a successful handover report or a successful PSCell report container. In this way, if the base station which the target PSCell belongs to and the base station which the source PSCell belongs to are base stations supporting different radio access technologies, the base station which the target PSCell belongs to may not need to parse or refer to the RRC encoding of the radio access technology supported by the source PSCell, thus reducing a complexity of implementation of the base station. The base station which the source PSCell belongs to can also transmit information on resulting in the successful handover report or the successful PSCell change report and/or information related to the base station which the target PSCell belongs to, such as configuration information related to the timer T304, to the base station which the target PSCell belongs to through the base station 1, instead of transmitting all information in the successful handover report or the successful PSCell change report, thus reducing the information transmitted in the inter-base station interface. The base station which the base station 1 belongs to can also transmit information on resulting in the successful handover report or the successful PSCell change report and/or information related to the base station which the target PSCell belongs to, such as configuration information related to the timer T304, to the base station which the target PSCell belongs to, instead of transmitting all information in the successful handover report or the successful PSCell change report, thus reducing information transmitted in the inter-base station interface.

The base station which the target PSCell belongs to receives the successful handover report or the successful PSCell change report, or receives information on the successful handover report or the successful PSCell change report. The base station which the target PSCell belongs to can optimize the subsequent PSCell changes.

The base station 1 herein may be a master node.

So far, the fifth method for supporting self-configuration and self-optimization in the present disclosure is described. By this method, the successful handover report or the successful PSCell change report, especially the successful handover report of the PSCell change procedure of inter-different RAT, can be supported, and the causes of potential failures can be correctly identified, so as to carry out reasonable optimization, reduce occurrence of a failure, ensure service continuity, and reduce labor cost of operators.

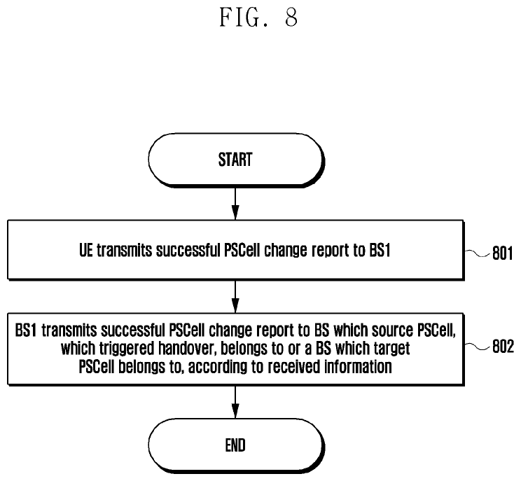

An example of the sixth method for supporting self-configuration and self-optimization in the present disclosure is illustrated in FIG. 8. The method comprises the following steps:

Step 801: a UE transmits a successful PSCell change report to the base station 1. The UE may transmit the successful PSCell change report to the base station 1 after the base station 1 requests the successful PSCell change report to the UE.

The successful PSCell change report may use a successful handover report or a newly defined successful PSCell change report. If the successful handover report is used, the UE can transmit information on the successful PSCell change report to the base station 1 through the successful handover report after the base station 1 requests the successful handover report report of the UE.

The UE may transmit the successful PSCell change report to the base station 1 through a UE information response message or other RRC message.

The successful handover report or the successful PSCell change report follows or refers to the RRC format of the radio access technology of the base station 1.

The cause of the successful PSCell change report in the message transmitted by the UE may also include the cause of the timer T316.

For the CPC or the CPA, the successful handover report transmitted by the UE may also include a time from the CPC or CPA configuration to the CPC or CPA execution.

The successful PSCell change report also includes the contents described at step 601, which will not be repeated here.

Step 802: the base station 1 transmits the successful PSCell change report to the base station which the source PSCell that triggered the handover belongs to or the base station which the target PSCell belongs to, according to the received information.

The base station 1 receives an RRC message containing the successful handover report or the successful PSCell change report from the UE.

The base station 1 transmits a message to the base station which the source PSCell belongs to or the base station which the target PSCell belongs to. According to the received information, the base station 1 decides to transmit a message to the base station which the source PSCell belongs to or the base station which the target PSCell belongs to.

The message contains a UE access stratum identity of the UE at the inter-base station interface.

The message contains the successful handover report or the successful PSCell change report.

The base station 1 may also include information in the successful handover report or the successful PSCell change report in the inter-base station interface message transmitted to the source SN or the target SN, instead of or in addition to including the successful handover report container or the successful PSCell report container in the inter-base station interface message, so that if the source SN or the target SN and the base station 1 are base stations supporting different radio access technologies, it is unnecessary for the source SN or the target SN to parse the RRC encoding according to the radio access technology supported by the base station 1, thus reducing a complexity of implementation of the base station. If the base station 1 transmits a message to the source SN, when the source SN and the base station 1 support different radio access technologies, the base station 1 includes the information in the successful handover report or the successful PSCell change report in the inter-base station interface message transmitted to the source SN, instead of or in addition to including the container of the successful handover report or the successful PSCell report in the inter-base station interface message. If the base station 1 transmits a message to the target SN, when the target SN and the base station 1 support different radio access technologies, the base station 1 includes the information in the successful handover report or the successful PSCell change report into the inter-base station interface message transmitted to the target SN, instead of or in addition to including the container of the successful handover report or the successful PSCell report in the inter-base station interface message.

If the base station 1 transmits a message to the source SN, the base station 1 can also transmit information on resulting in a successful handover report or a successful PSCell change report and/or information related to the source SN (for example, configuration information related to the timer T310 or T312) to the source SN, instead of transmitting all information in the successful handover report or the successful PSCell change report to the source SN, thus reducing the information transmitted in the inter-base station interface.

If the base station 1 transmits a message to the target SN, the base station 1 can also transmit information on resulting in a successful handover report or a successful PSCell change report and/or information related to the target SN (for example, configuration information related to the timer T304) to the SN, instead of transmitting all information in the successful handover report or the successful PSCell change report to the SN, thus reducing the information transmitted in the inter-base station interface.

The source SN or the target SN receives the successful handover report or the successful PSCell change report, or receives information on the successful handover report or the successful PSCell change report. The source SN or the target SN can optimize the subsequent PSCell change.

The base station 1 herein may be a master node.

So far, the sixth method for supporting self-configuration and self-optimization in the present disclosure is described. By this method, the successful handover report or the successful PSCell change report, especially the successful handover report of the PSCell change procedure of inter-different RAT, can be supported, and the cause of a potential failures can be correctly identified, so as to carry out reasonable optimization, reduce occurrence of a failure, ensure service continuity, and reduce labor cost of operators.

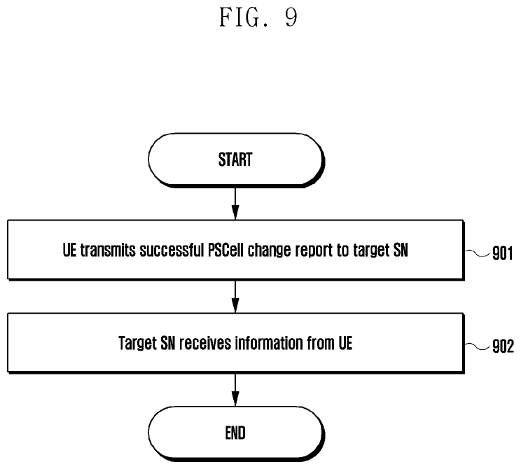

An example of the seventh method of the present disclosure supporting self-configuration and self-optimization is illustrated in FIG. 9. The method comprises the following steps:

Step 901: a UE transmits a successful PSCell change report to a target SN. The UE may transmit the successful PSCell change report to the target SN after the target SN requests the successful PSCell change report to the UE.

The UE can transmit the successful PSCell change report to the target SN through a Signaling Radio Bear 3 (SRB3).

The successful PSCell change report may use a successful handover report or a newly defined successful PSCell change report. If the successful handover report is used, the UE can transmit information on the successful PSCell change report to the target SN through the successful handover report after the target SN requests the successful handover report of the UE.

The UE can transmit the successful PSCell change report to the target SN through a UE information response message or other RRC message.

The successful handover report or the successful PSCell change report follows or uses the RRC format of the radio access technology supported by the target SN.

A cause of the successful PSCell change report in the message transmitted by the UE may also include the cause of the timer T316.

For the CPC or the CPA, the successful handover report transmitted by the UE may also include a time from CPC or CPA configuration to CPC or CPA execution.

The successful PSCell change report also includes the contents described at step 601, which will not be repeated here.

Step 902: The target SN receives the information from the UE.

The target SN receives an RRC message containing the successful handover report or the successful PSCell change report from the UE.

If the successful PSCell change report is caused by the configuration of the target SN, for example, caused by the configuration related to the timer T304, the target SN optimizes the candidate PSCell change.

If the successful handover report is not caused by the configuration of the target SN, the target SN transmits the successful PSCell change report to the base station 1. The base station 1 transmits the successful PSCell change report to the source SN.

If the successful PSCell change report is not caused by the configuration of the target SN, for example, it is caused by the configuration related to the timer T310 or the timer T312, the target SN transmits a message to the base station 1. The message contains a UE access stratum identity of the UE on an inter-base station interface. The message contains the successful handover report or the successful PSCell change report. The target SN may also include information in the successful handover report or the successful PSCell change report in an inter-base station interface message transmitted to the base station 1, instead of or in addition to including the successful handover report container or the successful PSCell report container in the inter-base station interface message. In this way, if the target SN and the base station 1 are base stations supporting different radio access technologies, it is unnecessary for the base station 1 to parse the RRC encoding which follows or refers to the radio access technology supported by the target SN, thus reducing a complexity of a base station implementation.

The base station 1 receives a message from the target SN. The base station 1 transmits a message to the source SN. The message contains a UE access stratum identity of the UE on an inter-base station interface. The message contains the successful handover report or the successful PSCell change report. The message may also contain information in the successful handover report or the successful PSCell change report, instead of or in addition to including the successful handover report container or the successful PSCell report container. In this way, if the source SN and the target SN are base stations supporting different radio access technologies, it is unnecessary for the source SN to parse the RRC encoding according to the radio access technologies supported by the target SN, thus reducing a complexity of the base station implementation. It is may be by the target SN that the information on the successful handover report or the successful PSCell change report is included in the inter-base station interface message transmitted to the base station 1, and the base station 1 directly forwards the message to the source SN upon receiving the same; or, the target SN transmits a container of the successful handover report or the successful PSCell change report to an MN, and after receiving the same, the MN includes information on the successful handover report or the successful PSCell change report in the inter-base station interface message transmitted to the source SN; or, the target SN transmits a container of the successful handover report or the successful PSCell change report to the MN, and after receiving the same, the MN transmits the container of the successful handover report or the successful PSCell change report to the source SN. The last method is suitable for the scenario where the source SN and the target SN support the same radio access technology.

The target SN may also transmit, to the source SN through the base station 1, information on resulting in the successful handover report or the successful PSCell change report and/or information related to the source SN, for example, configuration information related to the timer T310 or T312, instead of all information in the successful handover report or the successful PSCell change report, so that the information transmitted in the inter-base station interface can be reduced. Alternatively, the base station 1 receives all information in the successful handover report or the successful PSCell change report, and the base station 1 can also transmit the information on resulting in the successful handover report or the successful PSCell change report and/or information related to the source SN (for example, the configuration information related to the timer T310 or T312) to the source SN, instead of transmitting all information in the successful handover report or the successful PSCell change report to the source SN, so that the information transmitted in the inter-base station interface can be reduced.

The source SN receives the successful handover report or the successful PSCell change report, or receives information on the successful handover report or the successful PSCell change report. The source SN can optimize the subsequent PSCell changes.

The base station 1 herein may be a master node.

So far, the seventh method for supporting self-configuration and self-optimization in the present disclosure is described. By this method, the successful handover report or the successful PSCell change report, especially the successful handover report of the PSCell change procedure of inter-different RAT, can be supported, and the cause of potential failures can be correctly identified, so as to carry out reasonable optimization, reduce occurrence of a failure, ensure service continuity, and reduce labor cost of operators.

It should be noted that the above method is also applicable when at least two of the MN, the source SN and the target SN support the same radio access technology. For example, when the MN, the source SN and the target SN support the same radio access technology, the successful handover report or the successful PSCell change report is encoded according to the RRC of the radio access technology supported by the MN, the source SN and the target SN, and the UE transmits the successful handover report or the successful PSCell change report to the base station through the RRC message of the radio access technology. Which base station that the message is transmitted to is as described in various embodiments of the present disclosure.

So far, the method for supporting self-configuration and self-optimization in the present disclosure is described. Through this method, in the case of the master cell group failure in the dual connectivity state, the failure cause can be correctly identified, so as to make reasonable optimization, reduce occurrence of a failure, ensure service continuity and reduce labor cost of operators. Through this method, the successful handover report, especially successful handover reports of the handover of inter-different RAT, can be supported, and the causes of potential failures can be correctly identified, so as to make reasonable optimization, avoid a failure, ensure service continuity and reduce labor cost of operators. Through this method, the successful PSCell change report, especially the successful handover report in the PSCell change procedure of inter-different RAT, can be supported, and the cause of potential failures can be correctly identified, so as to make reasonable optimization, reduce occurrence of a failure, ensure service continuity and reduce labor cost of operators.

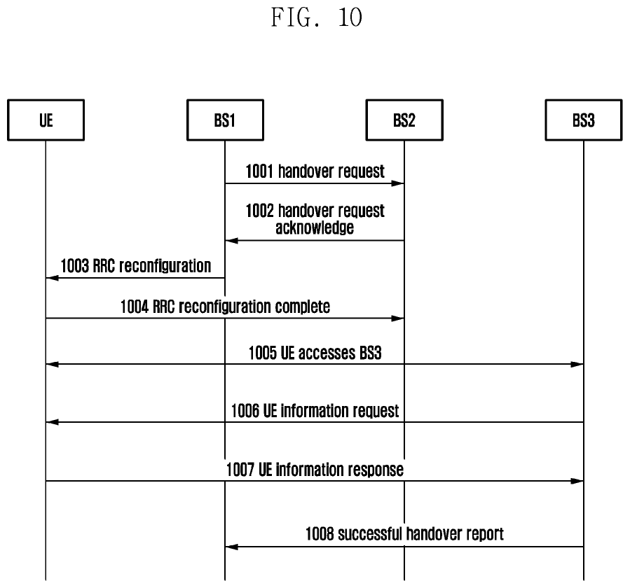

An example of the eighth method for supporting self-configuration and self-optimization in the present disclosure is illustrated in FIG. 10. The embodiment can be used for handover from an NR base station to an LTE base station (such as an LTE base station (ng-eNB) connected to a 5G core network), and can also be used for an inter-base station handover with the same radio access technology or for an inter-base station handover with different radio access technologies or for an inter-system handover. The method comprises the following steps:

Step 1001: The base station 1 transmits a handover request message to the base station 2. The base station 1 is a source base station and the base station 2 is a target base station. The handover request message contains a T310 threshold percentage and/or a T312 threshold percentage. The handover request message contains a UE identity. The UE identity is used for identifying a UE context or a UE mobility context or a UE handover context or UE handover trigger information. The UE identity may be a UE identity longer than the C-RNTI or the C-RNTI of the UE in the source cell. The UE identity may be a UE identity uniquely identifying the UE in the source base station. The handover request message contains mobility information. The mobility information is mobility information of the UE in the source cell or mobility information of the UE in the source base station. The base station 2 stores the received information.

When it is used for a handover from an NR base station to an ng-eNB, the base station 1 is a gNB.

Step 1002: the base station 2 transmits a handover request acknowledge message to the base station 1. The handover request acknowledge message contains successful handover configuration. The successful handover configuration includes a T310 threshold percentage and/or a T312 threshold percentage and/or a T304 threshold percentage. The handover request acknowledge message contains the UE identity and/or the mobility information received from the base station 1. The UE identity may be a UE identity of the UE in the source cell or a UE identity of the UE in the source base station. The UE identity may be a C-RNTI of the UE in the source cell or a UE identity longer than the C-RNTI, received from the source base station. The UE identity and/or the mobility information received from the source base station may be included in a transparent container from the target radio network node to the source radio network node. The base station 2 may include the UE identity or the mobility information received from the source base station when the successful handover configuration includes the T310 threshold percentage and/or the T312 threshold percentage. The handover request acknowledge message may also include the mobility information of the UE in the target cell or the target base station. The handover request acknowledge message may also include a UE identity of the UE in the target cell or the target base station. The mobility information of the UE in the target cell or the UE identity of the UE in the target cell or the target base station may be included in a transparent container from the target radio network node to the source radio network node. The transparent container from the target radio network node to the source radio network node contains a handover command message.

Step 1003: the base station 1 transmits an RRC reconfiguration message to the UE. The RRC reconfiguration message is used to transmit the handover command message received from the base station 2 to the UE. The handover command message contains information in the transparent container from the target radio network node to the source radio network node received from the base station 2.

If the UE is configured with a successful handover configuration, after the UE successfully completes a random access procedure with the target cell, the UE performs a successful handover report decision. If the ratio of running time of T310 to the configured T310 value is greater than the T310 threshold percentage included in the successful handover configuration, the UE stores the successful handover information in the successful handover report variable, and the UE can store the successful handover report according to the RRC format supported by the source base station. If the T312 associated with a measurement identity of the target cell is still running when synchronization reconfiguration procedure is initiated, and the ratio of the running time of the T312 to the configured T312 value is greater than the T312 threshold percentage included in the successful handover configuration, the UE stores the successful handover information in the successful handover report variable, and the UE can store the successful handover report according to the RRC format supported by the source base station. If the ratio of the running time of T304 to the configured T304 value is greater than the T304 threshold percentage included in the successful handover configuration, the UE stores the successful handover information in the successful handover report variable. The UE can store the successful handover report according to the RRC format supported by the source base station or the target base station.

The successful handover information stored by the UE includes information that the trigger of successful handover report is the cause of the T310 and/or the T312 and/or the T304. The successful handover information stored by UE includes information on the source cell, information on the target cell, measurement result of neighboring cells, location information, common random access information, interruption time of the user plane, a UE identity of the UE in the source cell or the source base station, mobility information of the UE in the source base station or the source cell, a UE identity of the UE in the target cell or the target base station, mobility information of the UE in the target base station or the target cell, a time from the UE transmitting a handover complete or an RRC reconfiguration complete to the UE transmitting the successful handover report to the base station, a time from handover execution to the UE transmitting the successful handover report to the base station, and/or a time from the UE receiving a handover command to the UE transmitting the successful handover report to the base station.

Step 1004: the UE transmits the RRC reconfiguration complete message to the base station 2.

If there is successful handover information in the successful handover report variable and the registered public land mobile network is included in a PLMN identity list in the successful handover report variable, the UE can include successful handover information being available in the RRC reconfiguration complete message. For the inter-base station handover with the same radio access technology, the UE can transmit the successful handover report to the target base station.

For an inter-radio access technology handover, such as a handover from an NR base station to an LTE base station, if the successful handover report is caused by the T310 and/or T312 threshold percentage configured by the source base station, when the UE returns to a base station supporting the same radio access technology as the source base station, the UE can transmit the successful handover information being available to the base station. For example, for a handover from an NR base station to an LTE base station, when the UE returns to an NR base station, the UE can transmit the successful handover information being available to the accessed NR base station. When the UE returns to the NR base station and the registered public land mobile network is included in the PLMN identity list in the successful handover report variable, the UE can transmit the successful handover information being available to the NR base station.

As for an inter-different radio access technology handover, for example, a handover from an NR base station to an LTE base station, if the successful handover report is caused by the T304 threshold percentage configured by the target base station, in case that there is the successful handover information in the successful handover report variable, the UE can include the successful handover information being available in the RRC reconfiguration complete message. If there is successful handover information in the successful handover report variable and the registered public land mobile network is included in the PLMN identity list in the successful handover report variable, the UE can include the successful handover information being available in the RRC reconfiguration complete message.

The base station 2 transmits a UE information request message to the UE for requesting the successful handover report. The UE transmits a UE information response message to the base station 2. The UE information response message contains the successful handover report. The successful handover report contains the UE identity of the UE in the target cell or the target base station. The UE identity may be a C-RNTI. The successful handover report contains the mobility information of the UE in the target cell or the target base station. The mobility information of the UE in the target cell or the target base station is received by the UE from the base station at step 1003. The successful handover report also includes the successful handover information stored by the UE at step 1003.

If the UE has transmitted the stored successful handover report to the base station, the subsequent steps do not need to be executed.

Step 1005: the UE accesses the base station 3. The UE may access the base station 3 through a handover procedure or an RRC connection setup procedure from an idle mode to a connected mode or an RRC reestablishment procedure.

If there is successful handover information in the successful handover report variable and the registered public land mobile network is included in the PLMN identity list in the successful handover report variable, the UE can include the successful handover information being available in the RRC reconfiguration complete message. When the base station 3 and the base station 1 support the same radio access technology, for example, both the base station 3 and the base station 1 are gNBs, if there is the successful handover information in the successful handover report variable and the registered public land mobile network is included in the PLMN identity list in the successful handover report variable, the UE can include the successful handover information being available in the RRC reconfiguration complete message. If the successful handover report is caused by the T310 and/or T312 threshold percentage configured by the source base station, when the base station 3 and the base station 1 support the same radio access technology, for example, both the base station 3 and the base station 1 are gNBs, if there is the successful handover information in the successful handover report variable and the registered public land mobile network is included in the PLMN identity list in the successful handover report variable, the UE can include the successful handover information being available the RRC reconfiguration complete message. If the successful handover report is caused by the T304 threshold percentage configured by the target base station, when the base station 3 and the base station 2 support the same radio access technology, for example, both the base station 3 and the base station 2 are ng-eNBs, if there is the successful handover information in the successful handover report variable and the registered public land mobile network is included in the PLMN identity list in the successful handover report variable, the UE can include the successful handover information being available in the RRC reconfiguration complete message.

Step 1006: the base station 3 transmits a UE information request message to the UE for requesting the successful handover report. The base station 3 requests the successful handover report of the UE when receiving the successful handover information being available.

Step 1007: the UE transmits a UE information response message to the base station 3. The UE information response message contains the successful handover report. The successful handover report is a value of the successful handover report in the successful handover report variable. The successful handover report or the information in the successful handover report variable specifically includes the successful handover information stored by the UE at step 1003. The successful handover report contains a UE identity or mobility information of the UE in the source base station or the source cell. If the successful handover report is caused by the T310 and/or T312, the successful handover report contains the UE identity or the mobility information of the UE in the source base station or the source cell. The successful handover report contains a cell identity of the source cell serving the UE in the source base station. The successful handover report contains information that the trigger of successful handover report is the cause of the T310 and/or T312 and/or T304. The successful handover report also includes the successful handover information stored by the UE at step 1003.

Step 1008: the base station 3 transmits the successful handover report received from the UE to the base station 1. The base station 3 can transmit the successful handover report received from the UE to the base station 1 through an access and mobility information message. The base station 3 may also transmit the successful handover report received from the UE to the base station 1 through other message. The base station 3 knows the base station 1 according to the identity of the source cell contained in the successful handover report, so as to transmit the successful handover report received from the UE to the base station 1. The base station 1 finds the UE context or the UE mobility context or the UE handover context or the UE handover trigger information according to the UE identity or the mobility information of the UE in the source base station or the source cell contained in the successful handover report, or the base station 1 finds the UE context or the UE mobility context or the UE handover context or the UE handover trigger information according to the UE identity of UE in the source base station or the source cell and a time from the UE receiving the handover command to transmitting the successful handover report to the base station contained in the successful handover report, or the base station 1 finds the handover related information or the UE context according to the mobility information of the UE in the source base station or the source cell, so as to optimize the subsequent handover accordingly.

If the successful handover report contains information that the successful handover report is caused by the T310 and/or T312, the base station 3 transmits the successful handover report received from the UE to the base station 1, and the base station 3 knows the base station 1 according to the identity of the source cell contained in the successful handover report, so as to transmit the successful handover report received from the UE to the base station 1. The base station 1 finds the UE context or the UE mobility context or the UE handover context or the UE handover trigger information according to the UE identity or the mobility information of the UE in the source base station or the source cell contained in the successful handover report, or the base station 1 finds the UE context or the UE mobility context or the UE handover context or the UE handover trigger information according to the UE identity of UE in the source base station or the source cell and the time from the UE receiving the handover command to transmitting the successful handover report to the base station contained in the successful handover report, or the base station 1 finds the handover related information or the UE context according to the mobility information, so as to optimize the subsequent handover accordingly.

If the trigger of successful handover report is the cause of the T304, the source base station performs corresponding optimization, or the base station 3 transmits the successful handover report to the target base station. There are two methods for the base station transmitting the successful handover report to the target base station. Method 1: The base station 3 transmits the successful handover report received from the UE to the target base station according to the information that the trigger of successful handover report is the cause of the T304 in the successful handover report. Method 2: The base station 3 transmits the successful handover report received from the UE to the source base station, and the source base station transmits the successful handover report to the target base station according to the information that the trigger of successful handover report is the cause of the T304 in the successful handover report. The two methods are described in detail below.

Method 1:

If the successful handover report contains the information that cause of the successful handover report is the cause of the T304, the base station 3 transmits the successful handover report received from the UE to the base station 2, and the base station 3 knows the base station 2 according to the identity of the target cell contained in the successful handover report, so as to transmit the successful handover report received from the UE to the base station 2. The base station 2 finds the UE context or the UE mobility context or the UE handover context or the UE handover trigger information according to the UE identity or the mobility information of the UE in the target cell or the target base station contained in the successful handover report, or the base station 2 finds the UE context or the UE mobility context or the UE handover context or the UE handover trigger information according to the UE identity of the UE in the target base station or the target cell and the time from the UE transmitting the handover complete or the reconfiguration complete to transmitting the successful handover report to the base station contained in the successful handover report, or the base station 2 finds the UE context or the UE mobility context or the UE handover context or the UE handover trigger information according to the UE identity of the UE in the target base station or the target cell and the time from executing the handover to transmitting the successful handover report to the base station contained in the successful handover report, or the base station 2 finds the handover related information or the UE context according to the mobility information, so as to optimize the subsequent handover accordingly.

Method 2:

The base station 1 receives the successful handover report. If the successful handover report contains the information that the trigger of successful handover report is the cause of the T304, the base station 1 transmits the received successful handover report to the base station 2, and the base station 1 knows the base station 2 according to the identity of the target cell contained in the successful handover report, so as to transmit the successful handover report to the base station 2. The base station 2 finds the UE context or the UE mobility context or the UE handover context or the UE handover trigger information according to the UE identity or the mobility information of the UE in the target cell or the target base station contained in the successful handover report, or the base station 2 finds the UE context or the UE mobility context or the UE handover context or the UE handover trigger information according to the UE identity of the UE in the target base station or the target cell and the time from the UE transmitting the handover complete or the reconfiguration complete to transmitting the successful handover report to the base station contained in the successful handover report, or the base station 2 finds the UE context or the UE mobility context or the UE handover context or the UE handover trigger information according to the UE identity of the UE in the target base station or the target cell and the time from handover execution to transmitting the successful handover report to the base station contained in the successful handover report, or the base station 2 finds the handover related information or the UE context according to the mobility information, so as to optimize the subsequent handover accordingly.

So far, the method for supporting self-configuration and self-optimization in the present disclosure is described. Through this method, the successful handover reports, especially the successful handover reports of the inter-RAT, can be supported, and the causes of potential failures can be correctly identified, so as to make reasonable optimization, avoid a failure, ensure service continuity and reduce labor cost of operators. The method of the present disclosure can also avoid or reduce the influence on the target base station.

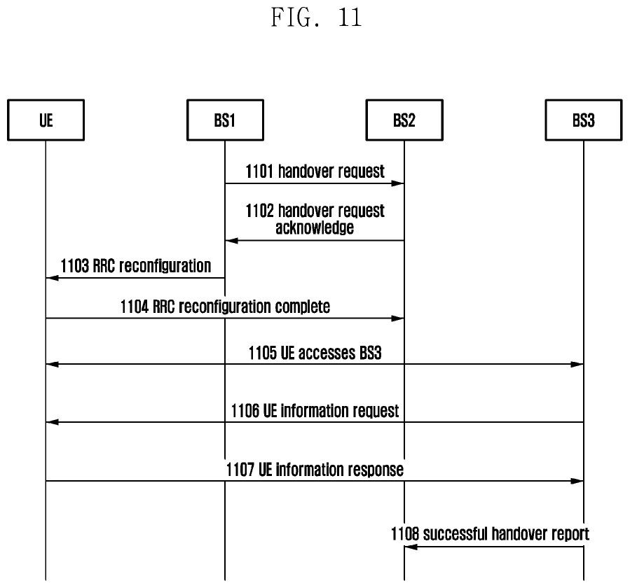

An example of the ninth method for supporting self-configuration and self-optimization in the present disclosure is illustrated in FIG. 11. This embodiment can be used for a handover from an LTE base station (such as an LTE base station (ng-eNB) connected to a 5G core network) to an NR base station, and can also be used for an inter-base station handover with the same radio access technology or an inter-base station handover with different radio access technologies or an inter-system handover. The method comprises the following steps:

Step 1101: The base station 1 transmits a handover request message to the base station 2. The base station 1 is a source base station and the base station 2 is a target base station. The handover request message contains a T310 threshold percentage and/or a T312 threshold percentage. The handover request message contains a UE identity. The UE identity is used for identifying a UE context or a UE mobility context or a UE handover context or UE handover trigger information. The UE identity may be a UE identity longer than the C-RNTI or the C-RNTI of the UE in the source cell. The UE identity may be a UE identity uniquely identifying the UE in the source base station. The handover request message contains mobility information. The mobility information is mobility information of the UE in the source cell. The mobility information is mobility information of the UE in the source cell or mobility information of the UE in the source base station. The base station 2 stores the received information.

As for a handover from an LTE base station to an NR base station, the base station 2 is gNB.

Step 1102: the base station 2 transmits a handover request acknowledge message to the base station 1. The handover request acknowledge message contains a successful handover configuration. The successful handover configuration includes the T310 threshold percentage and/or the T312 threshold percentage and/or a T304 threshold percentage. The handover request acknowledge message contains the UE identity and/or the mobility information received from the base station 1. The UE identity may be a UE identity of the UE in a source cell or a UE identity of the UE in a source base station. The UE identity may be a C-RNTI of the UE in the source cell or a UE identity longer than the C-RNTI, received from the source base station. The UE identity and/or the mobility information received from the source base station may be included in a transparent container from the target radio network node to the source radio network node. The base station 2 may include the UE identity or the mobility information received from the source base station when including the T310 threshold percentage and/or the T312 threshold percentage in the successful handover configuration. The handover request acknowledge message may also include the mobility information of the UE in the target cell or the target base station. The handover request acknowledge message may also include the UE identity of the UE in the target cell or the target base station. The mobility information of the UE in the target cell or the target base station and/or the UE identity of the UE in the target cell or the target base station may be included in a transparent container from the target radio network node to the source radio network node. The base station 2 may include the mobility information of the UE in the target cell or the target base station and/or the UE identity of the UE in the target cell or the target base station when the T304 threshold percentage is configured. The transparent container from the target radio network node to the source radio network node contains the handover command message.

Step 1103: the base station 1 transmits an RRC reconfiguration message to the UE. The RRC reconfiguration message is used to transmit the handover command message received from the base station 2 to the UE. The handover command message contains information in the transparent container from the target radio network node to the source radio network node received from the base station 2.

If the UE is configured with the successful handover configuration, after the UE successfully completes a random access procedure with the target cell, the UE performs a successful handover report decision. If the ratio of the running time of the T310 to the configured T310 value is greater than the T310 threshold percentage included in the successful handover configuration, the UE stores the successful handover information in the successful handover report variable, and the UE can store the successful handover report according to the RRC format supported by the source base station. If when the reconfiguration procedure initiating the synchronization is executed, the T312 associated with a measurement identity of the target cell is still running, and the ratio of the running time of the T312 to the configured T312 value is greater than the T312 threshold percentage included in the successful handover configuration, the UE stores the successful handover information in the successful handover report variable, and the UE can store the successful handover report according to the RRC format supported by the source base station. If the ratio of the running time of the T304 to the configured T304 value is greater than the T304 threshold percentage included in the successful handover configuration, the UE stores the successful handover information in the successful handover report variable. The UE can store the successful handover report according to the RRC format supported by the source base station or the target base station.

The successful handover information stored by the UE includes information that the trigger of successful handover report is the cause of the T310 and/or the T312 and/or the T304. The successful handover information stored by UE includes information on the a source cell, information on the target cell, measurement result of neighboring cells, location information, common random access information, interruption time of the user plane, a UE identity of the UE in the source cell or the source base station, mobility information of the UE in the source base station or the source cell, a UE identity of the UE in the target cell or the target base station, mobility information of the UE in the target base station or the target cell, a time from the UE transmitting the handover complete or the RRC reconfiguration to the UE transmitting the successful handover report to the base station, a time from handover execution to the UE transmitting the successful handover report to the base station, and/or a time from the UE receiving a handover command to transmitting a successful handover report to the base station.

Step 1104: the UE transmits an RRC reconfiguration complete message to the base station 2.

If there is successful handover information in the successful handover report variable and the registered public land mobile network is included in the PLMN identity list in the successful handover report variable, the UE can include the successful handover information being available in the RRC reconfiguration complete message. For the inter-base station handover with the same radio access technology, the UE can transmit a successful handover report to the target base station.

For an inter-different radio access technology handover, such as a handover from an LTE base station to an NR base station, if the successful handover report is caused by the T310 and/or the T312 threshold percentage configured by the source base station, the UE can transmit the successful handover report to the target base station, or when the UE returns to a base station supporting the same radio access technology as the source base station, the UE can transmit the successful handover information being available to the base station. For example, for the handover from an LTE base station to an NR base station, when the UE returns to an LTE base station, the UE can transmit the successful handover information being available to the accessed LTE base station. When the UE returns to the LTE base station and the registered public land mobile network is included in the PLMN identity list in the successful handover report variable, the UE can transmit the successful handover information being available to the LTE base station. Or, the UE can transmit the successful handover information being available to the NR base station, such as the target NR base station or a third NR base station.

For the inter-different radio access technology handover, for example, the handover from an LTE base station to an NR base station, if the successful handover report is caused by the T304 threshold percentage configured by the target base station, in case that there is the successful handover information in the successful handover report variable, the UE can include the successful handover information being available in the RRC reconfiguration complete message. If there is successful handover information in the successful handover report variable and the registered public land mobile network is included in the PLMN identity list in the successful handover report variable, the UE can include the successful handover information being available in the RRC reconfiguration complete message.

The base station 2 transmits a UE information request message to the UE for requesting the successful handover report. The UE transmits a UE information response message to the base station 2. The UE information response message contains the successful handover report. The successful handover report contains the UE identity of the UE in the target cell or the target base station. The successful handover report contains the mobility information of the UE in the target cell or the target base station. The mobility information of the UE in the target cell or the target base station is received by the UE from the base station at step 1103. The successful handover report also includes the successful handover information stored by the UE at step 1103.

If the UE has transmitted the stored successful handover report to the base station, the subsequent steps do not need to be executed.

Step 1105: the UE accesses the base station 3. The UE may access the base station 3 through a handover procedure or an RRC connection setup procedure from an idle mode to a connected mode or an RRC reestablishment procedure.

If there is the successful handover information in the successful handover report variable and the registered public land mobile network is included in the PLMN identity list in the successful handover report variable, the UE can include the successful handover information being available in the RRC reconfiguration complete message. In case that the base station 3 and the base station 1 support the same radio access technology, for example, both the base station 3 and the base station 1 are ng-eNBs, if there is the successful handover information in the successful handover report variable and the registered public land mobile network is included in the PLMN identity list in the successful handover report variable, the UE can include the successful handover information being available in the RRC reconfiguration complete message. If the successful handover report is caused by the T310 and/or T312 threshold percentage configured by the source base station, in case that the base station 3 and the base station 1 support the same radio access technology, for example, both the base station 3 and the base station 1 are ng-eNBs, if there is the successful handover information in the successful handover report variable and the registered public land mobile network is included in the PLMN identity list in the successful handover report variable, the UE can include the successful handover information being available in the RRC reconfiguration complete message. As another implementation in the present disclosure, in case that the base station 3 and the base station 1 support different radio access technologies, if there is the successful handover information in the successful handover report variable and the registered public land mobile network is included in the PLMN identity list in the successful handover report variable, the UE can include the successful handover information being available in the RRC reconfiguration complete message. If the successful handover report is caused by the T304 threshold percentage configured by the target base station, as another implementation in the present disclosure, in case that the base station 3 and the base station 2 support the same radio access technology, for example, both the base station 3 and the base station 2 are gNBs, if there is the successful handover information in the successful handover report variable and the registered public land mobile network is included in the PLMN identity list in the successful handover report variable, the UE can include the successful handover information being available in the RRC reconfiguration complete message.

Step 1106: the base station 3 transmits the UE information request message to the UE for requesting the successful handover report. The base station 3 requests the successful handover report of the UE when receiving the successful handover information being available.

Step 1007: the UE transmits the UE information response message to the base station 3. The UE information response message contains the successful handover report. The successful handover report is the value of the successful handover report in the successful handover report variable. The information in the successful handover report or the successful handover report variable specifically includes the successful handover information stored by the UE at step 1103. If the successful handover report is caused by the T304, the successful handover report includes the mobility information of the UE in the target cell or the target base station, and may also include the UE identity of the UE in the target cell or the target base station. The successful handover report contains a cell identity of the cell in the target base station. The successful handover report contains the UE identity or the mobility information of the UE in the source base station or the source cell. If the successful handover report is caused by the T310 and/or T312, the successful handover report contains the UE identity or the mobility information of the UE in the source base station or the source cell. The successful handover report contains a cell identity of the source cell serving the UE in the source base station. The successful handover report contains information that the trigger of successful handover report is the cause of the T310 and/or the T312 and/or the T304. The successful handover report also includes the successful handover information stored by the UE at step 1103.

Step 1108: the base station 3 transmits the successful handover report received from the UE to the base station 2. The base station 3 can transmit the successful handover report received from the UE to the base station 2 through an access and mobility information message. The base station 3 may also transmit the successful handover report received from the UE to the base station 2 through other message. The base station 3 knows the base station 2 according to the identity of the target cell contained in the successful handover report, so as to transmit the successful handover report received from the UE to the base station 2. The base station 2 finds the UE context or the UE mobility context or the UE handover context or the UE handover trigger information according to the UE identity or the mobility information of the UE in the target base station or the target cell contained in the successful handover report, or the base station 2 finds the UE context or the UE mobility context or the UE handover context or the UE handover trigger information according to the UE identity of UE in the target base station or the target cell and a time from the UE transmitting the handover complete or the reconfiguration complete to transmitting the successful handover report to the base station contained in the successful handover report, or the base station 2 finds the UE context or the UE mobility context or the UE handover context or the UE handover trigger information according to the UE identity of UE in the target base station or the target cell and a time from the UE executing the handover to transmitting the successful handover report to the base station contained in the successful handover report, or the base station 2 finds the handover related information or the UE context according to the mobility information of the UE in the target base station or the target cell, so as to optimize the subsequent handover accordingly.

If the successful handover report contains information that the trigger of successful handover report is the cause of the T304, the base station 3 transmits the successful handover report received from the UE to the base station 2, and the base station 3 knows the base station 2 according to the identity of the target cell contained in the successful handover report, so as to transmit the successful handover report received from the UE to the base station 2. The base station 2 finds the UE context or the UE mobility context or the UE handover context or the UE handover trigger information according to the UE identity or the mobility information of the UE in the target base station or the target cell contained in the successful handover report, or the base station 2 finds the UE context or the UE mobility context or the UE handover context or the UE handover trigger information according to the UE identity of UE in the target base station or the target cell and the time from the UE transmitting the handover complete or the reconfiguration complete to transmitting the successful handover report to the base station contained in the successful handover report, or the base station 2 finds the UE context or the UE mobility context or the UE handover context or the UE handover trigger information according to the UE identity of UE in the target base station or the target cell and the time from the UE executing the handover to transmitting the successful handover report to the base station contained in the successful handover report, or the base station 2 finds the handover related information or the UE context according to the mobility information of the UE in the target base station or the target cell, so as to optimize the subsequent handover accordingly.

If the trigger of successful handover report is the cause of the T310 and/or T312, there are two methods for transmitting the successful handover report to the source base station. Method 1: The base station 3 transmits the successful handover report received from the UE to the source base station according to the information that the trigger of successful handover report is the cause of the T310 and/or T312 in the successful handover report. Method 2: The base station 3 transmits the successful handover report received from the UE to the target base station, and the target base station transmits the successful handover report to the source base station according to the information that the trigger of successful handover report is the cause of the T310 and/or T312 in the successful handover report. The two methods are described in detail below.

Method 1:

If the successful handover report contains the information that the successful handover report is caused by the T310 and/or T312, the base station 3 transmits the successful handover report received from the UE to the base station 1, and the base station 3 knows the base station 1 according to the identity of the source cell contained in the successful handover report, so as to transmit the successful handover report received from the UE to the base station 1. The base station 1 finds the UE context or the UE mobility context or the UE handover context or the UE handover trigger information according to the UE identity or the mobility information of the UE in the source cell or the source base station contained in the successful handover report, or the base station 1 finds the UE context or the UE mobility context or the UE handover context or the UE handover trigger information according to the UE identity of the UE in the source base station or the source cell and the time from the UE receiving the handover command to transmitting the successful handover report to the base station contained in the successful handover report, or the base station 1 finds handover related information or the UE context according to the mobility information of the UE in the source base station or the source cell, so as to optimize the subsequent handover accordingly.

Method 2:

The base station 3 transmits the successful handover report received from the UE to the base station 2, and the base station 3 knows the base station 2 according to the identity of the target cell contained in the successful handover report, so as to transmit the successful handover report received from the UE to the base station 2. The base station 2 receives the successful handover report, and if the successful handover report contains the information that the trigger of successful handover report is the cause of the T310 and/or T312, the base station 2 transmits the successful handover report to the base station 1. The base station 2 knows the base station 1 according to the identity of the source cell contained in the successful handover report, so as to transmit the successful handover report received from the UE to the base station 1. The base station 1 finds the UE context or the UE mobility context or the UE handover context or the UE handover trigger information according to the UE identity or the mobility information of the UE in the source cell or the source base station contained in the successful handover report, or the base station 1 finds the UE context or the UE mobility context or the UE handover context or the UE handover trigger information according to the UE identity of the UE in the source base station or the source cell and the time from the UE receiving the handover command to transmitting the successful handover report to the base station contained in the successful handover report, or the base station 1 finds the handover related information or the UE context according to the mobility information, so as to optimize the subsequent handover accordingly.

So far, the method for supporting self-configuration and self-optimization in the present disclosure is described. Through this method, the successful handover report, especially the successful handover reports of inter-different RAT, can be supported, and the cause of potential failures can be correctly identified, so as to make reasonable optimization, avoid a failure, ensure service continuity and reduce labor cost of operators. The method of the present disclosure can also avoid or reduce the influence on the target base station.

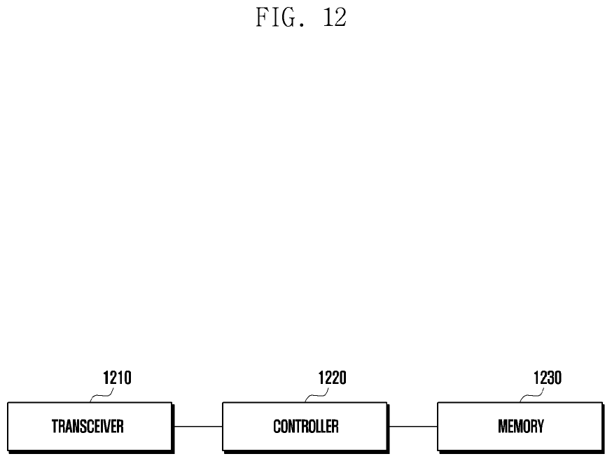

FIG. 12 illustrates a block diagram of a network node in a network according to the present disclosure.

The network node in the network can be used to implement the UE, the MN, the SN, the S-SN, the T-SN, other candidate T-SNs, etc. in the present disclosure. With reference to FIG. 12, the network node according to the present disclosure includes a transceiver 1210, a controller 1220 and a memory 1230. The transceiver 1210, the controller 1220 and the memory 1230 are configured to perform operations of the methods and/or embodiments of the present disclosure. Although the transceiver 1210, the controller 1220 and the memory 1230 are illustrated as separate entities, they can be implemented as a single entity, such as a single chip. The transceiver 1210, the controller 1220 and the memory 1230 may be electrically connected or coupled to each other. Transceiver 1210 can transmit signals to other network nodes and receive signals from other network nodes, such as the UE, the MN, the SN, the S-SN, the T-SN, other candidate T-SNs or core network nodes. The controller 1220 may include one or more processing units, and may control network nodes to perform operations and/or functions according to one of the above embodiments. The memory 1230 may store instructions for implementing the operations and/or functions of one of the above embodiments.

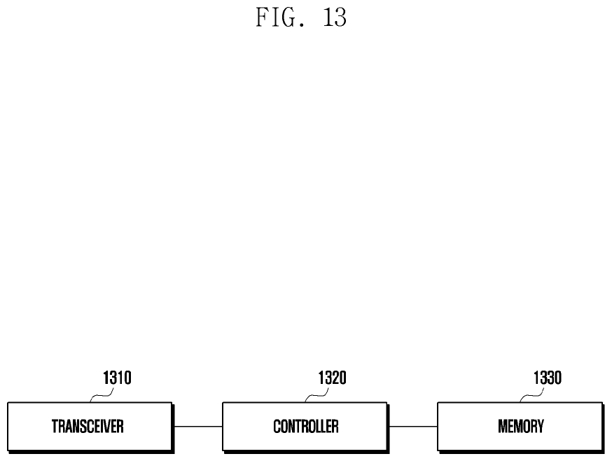

FIG. 13 illustrates a block diagram of a user equipment (UE) according to the present disclosure.

With reference to FIG. 13, the UE according to the present disclosure includes a transceiver 1310, a controller 1320 and a memory 1330. The transceiver 1310, the controller 1320 and the memory 1330 are configured to perform operations of the methods and/or embodiments of the present disclosure. Although the transceiver 1310, the controller 1320 and the memory 1330 are illustrated as separate entities, they can be implemented as a single entity, such as a single chip. The transceiver 1310, the controller 1320 and the memory 1330 may be electrically connected or coupled to each other. Transceiver 1310 can transmit signals to other network nodes and receive signals from other network nodes, such as the UE, the MN, the SN, the S-SN, the T-SN, other candidate T-SNs or core network nodes. The controller 1320 may include one or more processing units, and may control the UE to perform operations and/or functions according to one of the above embodiments. The memory 1330 may store instructions for implementing the operations and/or functions of one of the above embodiments.

Those skilled in the art will understand that the above illustrative embodiments are described herein and are not intended to be limiting. It should be understood that any two or more of the embodiments disclosed herein can be combined in any combination. In addition, other embodiments can be utilized and other changes can be made without departing from the spirit and scope of the subject matter presented herein. It will be readily understood that aspects of the present disclosure as generally described herein and illustrated in the drawings can be arranged, replaced, combined, separated and designed in various different configurations, all of which are contemplated herein.

Those skilled in the art will understand that various illustrative logical blocks, modules, circuits, and steps described in the present application can be implemented as hardware, software, or combinations of both. To clearly illustrate such interchangeability between hardware and software, various illustrative components, blocks, modules, circuits, and steps are generally described above in the form of their functional sets. Whether such a function set is implemented as hardware or software depends on the specific application and the design constraints imposed on the overall system. Technicians can implement the described set of functions in different ways for each specific application, but such design decisions should not be interpreted as causing a departure from the scope of the present application.

The various illustrative logic blocks, modules, and circuits described in the present application can be implemented with a general purpose processor, a Digital Signal Processor (DSP), an application specific integrated circuit (ASIC), a Field Programmable Gate Array (FPGA) or other programmable logic devices, discrete gate or transistor logic, discrete hardware components, or any combination thereof designed to perform the functions described herein. The general-purpose processor may be a microprocessor, but in an alternative, the processor may be any conventional processor, controller, microcontroller, or state machine. The processor can also be implemented as a combination of computing devices, such as a combination of a DSP and a microprocessor, a plurality of microprocessors, one or more microprocessors cooperating with a DSP core, or any other such configuration.

The steps of the method or algorithm described in the present application can be directly embodied in hardware, in a software module executed by a processor, or in a combination of the two. The software modules may reside in RAM memory, flash memory, ROM memory, EPROM memory, EEPROM memory, registers, hard disks, removable disks, or any other form of storage media known in the art. An exemplary storage medium is coupled to the processor so that the processor can read and write information from/to the storage medium. In an alternative, the storage medium may be integrated into the processor. The processor and the storage medium may reside in the ASIC. The ASIC may reside in the user terminal. In an alternative, the processor and the storage medium may reside as discrete components in the user terminal.

In one or more exemplary designs, the functions can be implemented in hardware, software, firmware, or any combination thereof. If implemented in software, each function can be stored on or transferred by a computer-readable medium as one or more instructions or codes. Computer readable media include both computer storage media and communication media, the latter including any media that facilitates the transfer of computer programs from one place to another. Storage media can be any available media that can be accessed by general-purpose or special-purpose computers.

The above descriptions are only exemplary implementations of the present application, and are not intended to limit the protection scope of the present application, which is determined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first network node in a communication system, the method comprising:
receiving information related to a master cell group (MCG) failure; and
detecting a failure cause of the MCG failure based on the information related to the MCG failure,
wherein the information related to the MCG failure includes at least one of information on a primary secondary cell (PSCell) where a secondary cell group (SCG) failure happened, or information on the failure cause of the MCG failure.

2. The method of claim 1,
wherein the information related to the MCG failure further includes a type of the SCG failure in case that the failure cause of the MCG failure is the SCG failure.

3. The method of claim 2,
wherein the information on the PSCell includes a cell identity of the PSCell, and
wherein the SCG failure includes at least one of a SCG suspend or a SCG deactivation.

4. The method of claim 1,
wherein the failure cause of the MCG failure comprises at least one of the SCG failure, or a problem related to a timer T316.

5. The method of claim 1,
wherein the information related to the MCG failure is received from a terminal or a base station.

6. A method performed by a terminal in a communication system, the method comprising:
identifying a master cell group (MCG) failure; and
transmitting, to a first network node, information related to the MCG failure,
wherein the information related to the MCG failure includes at least one of information on a primary secondary cell (PSCell) where a secondary cell group (SCG) failure happened, or information on a failure cause of the MCG failure.

7. The method of claim 6,
wherein the information related to the MCG failure further includes a type of the SCG failure in case that the failure cause of the MCG failure is the SCG failure.

8. The method of claim 6,
wherein the information on the PSCell includes a cell identity of the PSCell, and
wherein the SCG failure includes at least one of a SCG suspend or a SCG deactivation.

9. The method of claim 6,
wherein the failure cause of the MCG failure comprises at least one of the SCG failure, or a problem related to a timer T316.

10. The method of claim 6, wherein the information related to the MCG failure is transferred to the first network node through a base station.

11. A first network node comprising:
a transceiver configured to:
receive information related to a master cell group (MCG) failure; and
a controller operatively coupled to the transceiver configured to:
detect a failure cause of the MCG failure based on the information related to the MCG failure,
wherein the information related to the MCG failure includes at least one of information on a primary secondary cell (PSCell) where a secondary cell group (SCG) failure happened, or information on the failure cause of the MCG failure.

12. The first network node of claim 11,
wherein the information related to the MCG failure further includes a type of the SCG failure in case that the failure cause of the MCG failure is the SCG failure.

13. The first network node of claim 12,
wherein the information on the PSCell includes a cell identity of the PSCell, and
wherein the SCG failure includes at least one of a SCG suspend or a SCG deactivation.

14. The first network node of claim 11,
wherein the failure cause of the MCG failure comprises at least one of the SCG failure, or a problem related to a timer T316.

15. The first network node of claim 11,
wherein the information related to the MCG failure is received from a terminal or a base station.

16. A terminal comprising:
a transceiver; and
a controller operatively coupled to the transceiver configured to:
identify a master cell group (MCG) failure; and
wherein the transceiver is configured to:
transmit, to a first network node, information related to the MCG failure,
wherein the information related to the MCG failure includes at least one of information on a primary secondary cell (PSCell) where a secondary cell group (SCG) failure happened, or information on a failure cause of the MCG failure.

17. The terminal of claim 16,
wherein the information related to the MCG failure further includes a type of the SCG failure in case that the failure cause of the MCG failure is the SCG failure.

18. The terminal of claim 17,
wherein the information on the PSCell includes a cell identity of the PSCell, and
wherein the SCG failure includes at least one of a SCG suspend or a SCG deactivation.

19. The terminal of claim 16,
wherein the failure cause of the MCG failure comprises at least one of the SCG failure, or a problem related to a timer T316.

20. The terminal of claim 16, wherein the information related to the MCG failure is transferred to the first network node through a base station.
